(19) United States
(12) Patent Application Publication
(10) Pub. No.: US 2018/0232829 A1
(43) Pub. Date: Aug. 16, 2018

(54) DYNAMIC IRREGULARITY MANAGEMENT

(71) Applicant: International Business Machines Corporation, Armonk, NY (US)

(72) Inventors: Austin J. Dorenkamp, Rochester, MN (US); Jonathan C.F. Fouk, Rochester, MN (US); Paul F. Gerver, Rochester, MN (US)

(21) Appl. No.: 15/430,443

(22) Filed: Feb. 10, 2017

(51) Int. Cl. G06Q 50/20; G06Q 10/10; G09B 7/00

(52) U.S. Cl. CPC G06Q 50/205; G09B 7/00; G06Q 10/10

(57) ABSTRACT

Disclosed aspects relate to dynamic irregularity management in a multiple-individual evaluation-activity environment. A set of activity data pertaining to the multiple-individual evaluation-activity environment may be collected. The set of activity data may include a first set of individual information for a first individual related to an evaluation-activity and a second set of individual information for a second individual related to the evaluation-activity. An irregular relationship may be identified with respect to the set of activity data. An irregularity event response action may be provided based on the irregular relationship.

### BACKGROUND

This disclosure relates generally to computer systems and, more particularly, relates to dynamic irregularity management in a multiple-individual evaluation-activity environment. Evaluation-activity environments may need to be monitored. As the number of individuals participating in evaluation-activities increases, the need for dynamic irregularity management may also increase.

### SUMMARY

Aspects of the disclosure relate to monitoring multi-user input through a compatible input source and comparing inputs of concurrent users to detect, for example, possible instances of cheating in an educational environment such as a classroom or testing center. Disclosed aspects utilize input-tracking to detect suspicious behavior from individuals participating in an evaluation-activity. By analyzing input of individuals, a central processing device may detect if an individual is likely to be copying an answer from or collaborating with another individual. The input may be relayed to the administrator-user and the individual may be monitored more closely for suspicious behavior. Suspicious behavior may be detected in real-time while the evaluation-activity is administered. Features may be carried-out in a non-intrusive manner without individuals knowing their input is being directly monitored.

Disclosed aspects relate to dynamic irregularity management in a multiple-individual evaluation-activity environment. A set of activity data pertaining to the multiple-individual evaluation-activity environment may be collected. The set of activity data may include a first set of individual information for a first individual related to an evaluation-activity and a second set of individual information for a second individual related to the evaluation-activity. An irregular relationship may be identified with respect to the set of activity data. An irregularity event response action may be provided based on the irregular relationship.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a high-level block diagram of a computer system for implementing various embodiments of the present disclosure, according to embodiments.

FIG. 2 is a flowchart illustrating a method for dynamic irregularity management in a multiple-individual evaluation-activity environment, according to embodiments.

FIG. 3 is a flowchart illustrating a method for dynamic irregularity management in a multiple-individual evaluation-activity environment, according to embodiments.

FIG. 4 is a flowchart illustrating a method for dynamic irregularity management in a multiple-individual evaluation-activity environment, according to embodiments.

FIG. 5 is a flowchart illustrating a method for dynamic irregularity management in a multiple-individual evaluation-activity environment, according to embodiments.

FIG. 6 is a flowchart illustrating a method for dynamic irregularity management in a multiple-individual evaluation-activity environment, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to monitoring multi-user input through a compatible input source and comparing inputs of concurrent users to detect, for example, possible instances of cheating in an educational environment such as a classroom or testing center. Disclosed aspects utilize input-tracking to detect suspicious behavior from individuals participating in an evaluation-activity. By analyzing input of individuals, a central processing device may detect if an individual is likely to be copying an answer from or collaborating with another individual. The input may be relayed to the administrator-user and the individual may be monitored more closely for suspicious behavior. Suspicious behavior may be detected in real-time while the evaluation-activity is administered. Features may be carried-out in a non-intrusive manner without individuals knowing their input is being directly monitored.

Evaluation-activities may occur in environments which are difficult to monitor for instances of suspicious behavior and cheating. Individuals may copy answers from a nearby individual or work together to share answers without the knowledge of the proctor or administrator. Without assigning a single proctor to each individual, it may be challenging to catch every instance of cheating during an evaluation-activity. Dynamic irregularity management may monitor each individual for suspicious behavior without requiring a proctor for every individual participating in the evaluation-activity.

Disclosed aspects include a central processing device connected to an input stream for each individual. The source of the input stream may include a compatible device, such as a smart pen or computer keyboard, which may relay the input of a user, such as handwritten letters or keystrokes, to the central processing device of the system. As data is received by the central processing device, the input of a specific input device may be registered with the system. The central processing device may generate a map of the room with the location of users and analyze input as the individuals begin the evaluation-activity. Similarities between two (or more) individuals may be recorded. Individuals may be assigned a score indicating a probability of cheating based on irregularity factors such as distance between individuals, timing between similar input, order of input, number of times recorded for similar input, and the like. The cheating score of an individual may increase at a faster rate if further cheating is suspected. When an individual has accumulated a cheating score higher than a predetermined threshold score, an alert may be sent to the administrator. The administrator may be notified through name, seat number, and cheating score. In this way, the administrator may more closely monitor the individual in question.

Aspects of the disclosure relate to a system, method, and computer program product for dynamic irregularity management in a multiple-individual evaluation-activity environment. A set of activity data pertaining to the multiple-individual evaluation-activity environment may be collected. The set of activity data may include a first set of individual information for a first individual related to an evaluation-activity and a second set of individual information for a second individual related to the evaluation-activity. An irregular relationship may be identified with respect to the set of activity data. An irregularity event response action may be provided based on the irregular relationship.

Disclosed aspects may monitor multiple individuals in an evaluation-activity environment. In embodiments, an irregularity factor may be computed for each individual. The irregularity factor may indicate a score related to the probability that the individual in question is cheating or behaving suspiciously. The irregularity factor may be computed based on a content match between two or more individuals, a temporal match for two or more individuals, a frequency of a temporal match for two or more individuals, or other irregularities. If the irregularity factor exceeds a certain predetermined threshold, an alert may be provided to the administrator-user. Disclosed aspects may provide an administrator-user with a map of individuals in the room. In various embodiments, the map may be provided to the administrator at all times during the evaluation-activity. The map may include probability scores for each individual. Altogether, aspects of the disclosure can have performance or efficiency benefits. Aspects may save resources such as bandwidth, disk, processing, or memory.

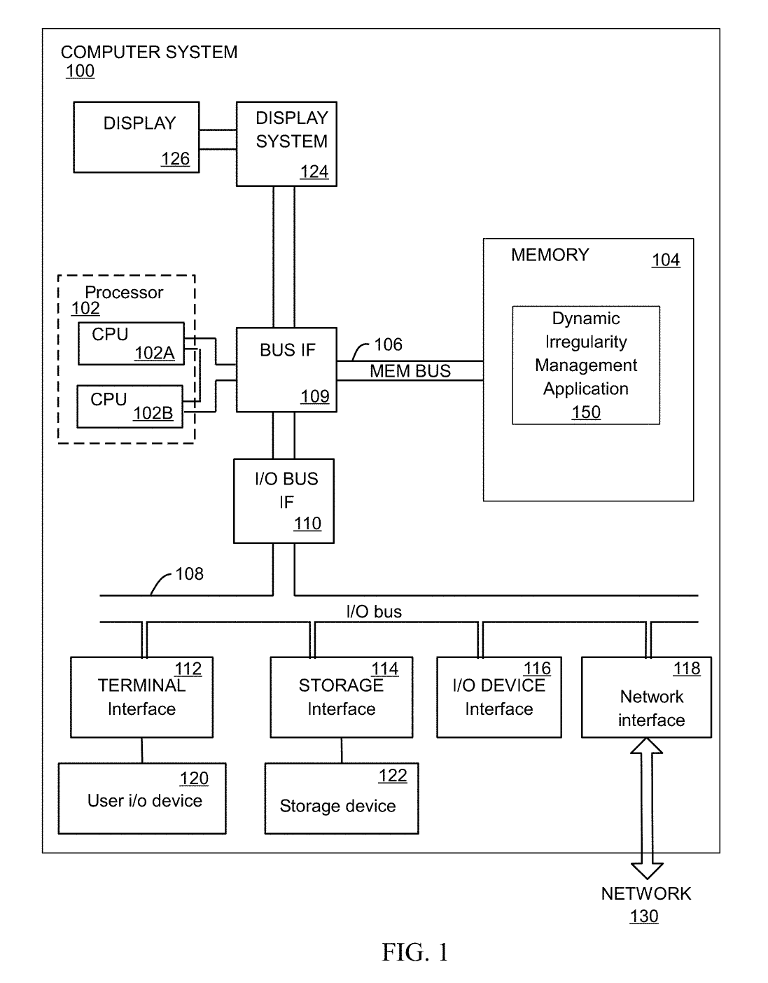

Turning now to the figures, FIG. 1 depicts a high-level block diagram of a computer system for implementing various embodiments of the present disclosure, according to embodiments. The mechanisms and apparatus of the various embodiments disclosed herein apply equally to any appropriate computing system. The major components of the computer system 100 include one or more processors 102, a memory 104, a terminal interface 112, a storage interface 114, an I/O (Input/Output) device interface 116, and a network interface 118, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 100 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 104 may store all or a portion of the various programs, modules and data structures for processing data transfers as discussed herein. For instance, the memory 104 can store a dynamic irregularity management application 150. In embodiments, the dynamic irregularity management application 150 may include instructions or statements that execute on the processor 102 or instructions or statements that are interpreted by instructions or statements that execute on the processor 102 to carry out the functions as further described below. In certain embodiments, the dynamic irregularity management application 150 is implemented in hardware via semiconductor devices, chips, logical gates, circuits, circuit cards, and/or other physical hardware devices in lieu of, or in addition to, a processor-based system. In embodiments, the dynamic irregularity management 150 may include data in addition to instructions or statements.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 114, 116, and 118, which are also known as I/O processors (IOPs) or I/O adapters (IOAs), through the I/O bus 108. The display system 124 may include a display controller, a display memory, or both. The display controller may provide video, audio, or both types of data to a display device 126. The display memory may be a dedicated memory for buffering video data. The display system 124 may be coupled with a display device 126, such as a standalone display screen, computer monitor, television, or a tablet or handheld device display. In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 120, which may include user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 120 and the computer system 100, and may receive output data via the user output devices. For example, a user interface may be presented via the user I/O device 120, such as displayed on a display device, played via a speaker, or printed via a printer.

The storage interface 114 supports the attachment of one or more disk drives or direct access storage devices 122 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 122 may be implemented via any type of secondary storage device. The contents of the memory 104, or any portion thereof, may be stored to and retrieved from the storage device 122 as needed. The I/O device interface 116 provides an interface to any of various other I/O devices or devices of other types, such as printers or fax machines. The network interface 118 provides one or more communication paths from the computer system 100 to other digital devices and computer systems; these communication paths may include, e.g., one or more networks 130.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown, which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

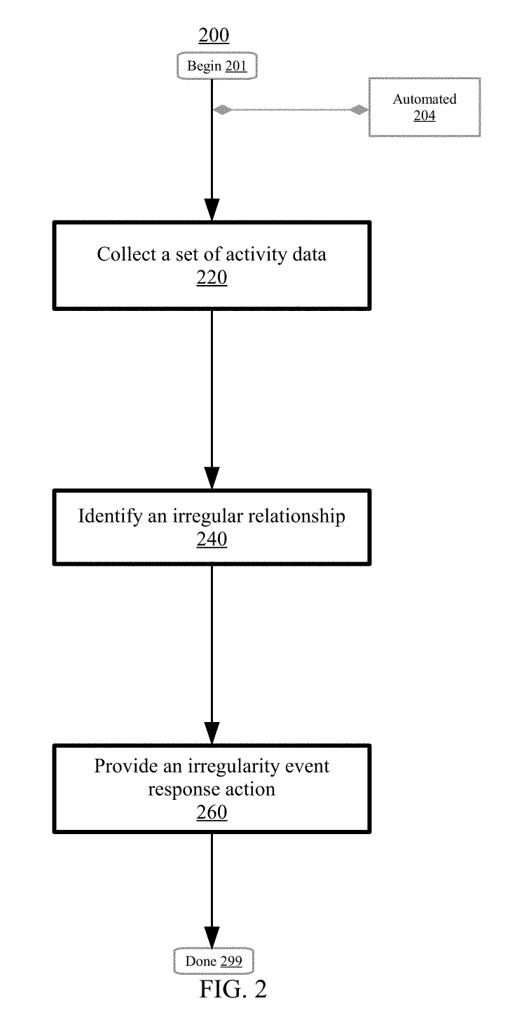

FIG. 2 is a flowchart illustrating a method 200 for dynamic irregularity management in a multiple-individual evaluation-activity environment, according to embodiments. Dynamic irregularities may include instances of cheating, rule-breaking, or unusual answers in an evaluation-activity. Dynamic irregularity management may relate to evaluating or monitoring instances of cheating, rule-breaking, or answers outside of the accepted norm in real-time, on-the-fly, or in an ongoing basis. As an example, an instance of an individual cheating may be monitored in real-time while the individual is participating in the evaluation-activity. The multiple-individual activity-environment may include an educational environment (e.g., a group of individual test takers, a homework assignment), a professional licensing environment (e.g., driver's license, law license, medical license), a certification environment (e.g., certification to handle chemicals, achieving a new level in a club, advancement in the military), an outdoor activity (e.g., scavenger hunt, race), or the like. In certain embodiments, the multiple-individual evaluation-activity environment may include small groups of test takers in a larger environment (e.g., a group test). The method 200 may begin at block 201.

In embodiments, the collecting, the identifying, the providing, and the other steps described herein may each be executed in an automated fashion at block 204. The steps described herein may be executed in an automated fashion without user intervention. The operational steps may each occur in an automated fashion without user intervention or manual action (e.g., using automated computer machinery, fully machine-driven without manual stimuli). The automated operational steps may be performed by a dynamic irregularity management engine (e.g., as part of a data management system), a cloud management engine (e.g., as part of a cloud environment), or the like.

At block 220, a set of activity data pertaining to the multiple-individual evaluation-activity environment may be collected. Generally, collecting can include capturing, gathering, aggregating, accumulating, or acquiring. The set of activity data may include information related to a particular test taker. The set of activity data may include information such as locality (e.g., global positioning system location), position (e.g., fifth row and fourth seat), a personal identifier (e.g., name, identification number, seat identifier), test question answers, temporal elements (e.g., time stamps, exam time length), or the like. The set of activity data may include a first set of individual information for a first individual related to an evaluation-activity and a second set of individual information for a second individual related to the evaluation activity. The first set of individual information may include the set of activity data for a first test taker (e.g., seat number of the first individual, test answers for the first individual) while the second set of individual information may include the set of activity data for a second test taker (e.g., seat number of the second individual, test answers for the second individual). In certain embodiments, the first set of individual information may be similar or the same as the second set of individual information. As an example, the first and second individuals may have similar or the same answers to test questions. The collecting may be performed by a dynamic irregularity management engine. The collecting may occur in a dynamic fashion to streamline dynamic irregularity management. The set of activity data may be collected for every individual in the testing environment. In this way, the set of activity data may be monitored for instances of cheating with respect to each individual.

Consider the following example. A dynamic irregularity management system may be used for a class of college students taking an exam. A set of activity data may be collected for every student in the room, including Student A. Student A may be equipped with a smart pen to answer exam questions. Student A may be seated in the first desk in the third row of seats. Student A may be assigned an ID number (e.g., 23). The set of activity for Student A may also include their answers to the exam questions. Student B may have his or her own set of activity data. Student B may be equipped with his or her own smart pen. Student B may be seated in the second desk in the third row of seats. Student B may be assigned an ID number (e.g., 24). The set of activity data for Student B may also include their answers to the exam questions. The activity data for Student A and Student B (along with the activity data for the other students taking the exam) may be monitored for instances of cheating by the dynamic irregularity management system. Other examples of collecting a set of activity data may also be possible.

At block 240, an irregular relationship may be identified with respect to the set of activity data. Generally, identifying can include recognizing, discovering, distinguishing, detecting, ascertaining, or determining. In certain embodiments, identifying can include determining the existence of an irregular relationship or determining the nature of an irregular relationship. The irregular relationship may include a connection, correlation, or association with the set of activity data which is unusual, unlikely, or improbable. The irregular relationship may indicate that the probability of cheating exceeds a threshold, an unusual number of answer similarities within a threshold time window, a high level of similarity (exceeding a threshold) of answers between two individuals located close to one another (compared to a threshold), an outlying question response, or the like. The identifying may occur based on the set of activity data pertaining to the multiple-individual evaluation-activity environment. The identifying may be performed by the dynamic irregularity management engine in the dynamic fashion to streamline dynamic irregularity management.

Consider the following example. A group of students may be taking an exam as described herein. An irregular relationship may be detected in the sets of activity for Student A and Student B. These two students may have the same answers for Questions 1-12. These two students may have both incorrectly answered Question 1, which is a question that students rarely answer incorrectly. Student A may have been detected to answer every question twenty seconds after Student B answered the question. Student A and B may have been detected to make the same spelling error for a particular question. Any unusual similarities or connections between the activity data for Students A and B may be identified as an irregular relationship which may indicate an instance of cheating or suspicious behavior. Other examples of identifying an irregular relationship may also be possible.

At block 260, an irregularity event response action may be provided based on the irregular relationship with respect to the set of activity data. Providing can include transmitting, conveying, presenting, displaying, highlighting, marking, indicating, or generating. In embodiments, the irregularity event response action may be provided to a user (e.g., an email, a text message, a flashing notification). In certain embodiments, the irregularity event response action may not require a user (e.g., an audio alarm, provided via a Graphical User Interface). The irregularity event response action may provide an alert regarding an existence of an irregular relationship. When there is a certain threshold level of likelihood of cheating, an alarm may be sent to a proctor. The proctor may be notified through name, seat number, a cheating score, a map, or the like. The central processing device may display a map (e.g., a heat map which changes colors) of the individuals in the exam room with cheating probability scores next to each seat. In certain embodiments, the map may be displayed to the proctor at all times. The providing may be performed by the dynamic irregularity management engine to streamline dynamic irregularity management.

Consider the following example. A group of students may be taking an exam as described herein. Student A and Student B may have made the same spelling error in a response for Question 4. The unusual spelling error made on the exams of two students sitting in close proximity to one another may indicate an irregular relationship. As an example, Student A may have copied the incorrectly spelled answer from Student B. An irregularity event response action may be provided to the professor. The professor may receive a text message from the central processing device. The text message may list the names of the students suspected of cheating (e.g., “Student A, Student B”). The professor may also be provided with a map of the students in the classroom. Students not suspected of cheating may have their location marked in blue. Since Student A and Student B have been suspected of cheating, their locations may be changed to red. The change in color of the map may indicate to the professor to closely monitor that section of the room. The map may be displayed to the professor throughout the entire exam and dynamically update (e.g., change color) when students are suspected of cheating. The professor may use the map to watch areas of the room where cheating is likely. Other examples of providing an irregularity event response action may also be possible.

Method 200 concludes at block 299. As described herein, aspects of method 200 relate to dynamic irregularity management in a multiple-individual evaluation-activity environment. Aspects of method 200 may provide performance or efficiency benefits related to dynamic irregularity management. Aspects may save resources such as bandwidth, processing, or memory. As an example, processing time may be saved through dynamically updating cheating probabilities of individuals. Updating and calculating a probability of cheating for each student in real-time (e.g., ongoing) may prevent an administrator-user from having to manually search for the cheating score any time an individual is suspected of cheating (e.g., the score is always displayed to the administrator and does not require any search time). Other examples of saving processing time using dynamic irregularity management may also be possible.

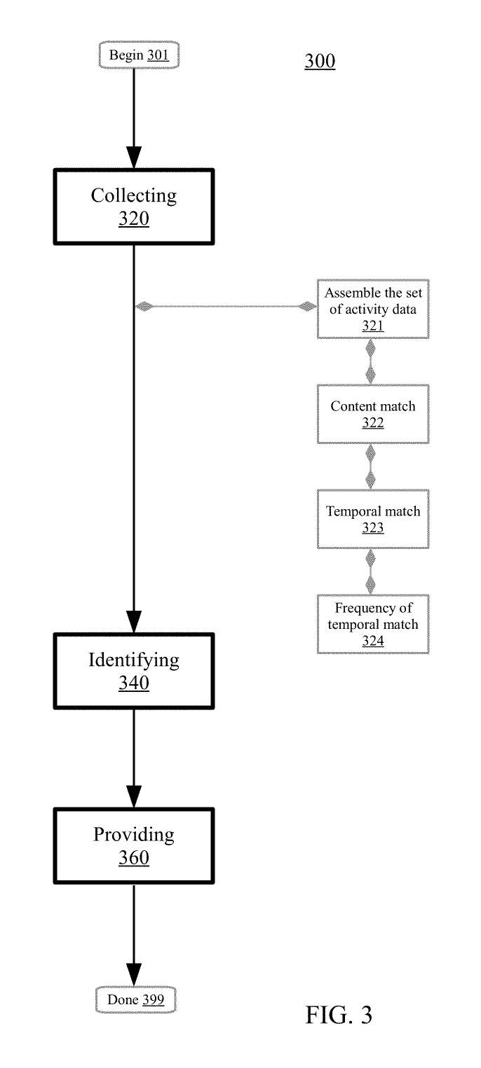

FIG. 3 is a flowchart illustrating a method 300 for dynamic irregularity management in a multiple-individual evaluation-activity environment, according to embodiments. Aspects of method 300 may be similar or the same as aspects of method 200, and aspects may be utilized interchangeably with one or more methodologies described herein. The method 300 may begin at block 301. At block 320, a set of activity data pertaining to the multiple-individual evaluation-activity environment may be collected. The set of activity data may include a first set of individual information for a first individual related to an evaluation-activity and a second set of individual information for a second individual related to the evaluation activity. The collecting may be performed by a dynamic irregularity management engine. The collecting may occur in a dynamic fashion to streamline dynamic irregularity management.

In embodiments, a first set of individual-input data may be received at block 321. Receiving can include ingesting, importing, collecting, gathering, acquiring, or obtaining. The first set of individual-input data may be information pertaining to the content and method of input of the content of a first individual user. As an example, the first set of individual-input data may include a compatible device (e.g., smart pens, computer keyboards) which is capable of relaying the input of a first user (e.g., handwritten letters/words, keystrokes) to the central processing device of the system. In certain embodiments, an individual may participate in an audio evaluation-activity. The compatible device may include a microphone or recording device to relay the speech of a user. The receiving may correspond to the first individual related to the evaluation-activity. A second set of individual-input data may be received related to the content and method of input of the content of a second individual user. The receiving may correspond to the second individual related to the evaluation-activity. The set of activity data may be assembled using the first and second sets of individual-input data. Generally, assembling can include compiling, generating, arranging, or organizing. The set of activity data may have the first set of individual information for the first individual related to the evaluation-activity and the second set of individual information for the second individual related to the evaluation-activity. The first and second sets of individual-input data may be assembled to create the set of activity data, which (in certain embodiments) may indicate an irregular relationship.

Consider the following example. A group of students may submit a homework assignment electronically. A set of individual-input data may be collected for each student with respect to the particular homework assignment. As an example, Student A may submit the homework assignment using a computer in the library. The keystrokes of Student A may be monitored to create a set of individual-input data. Student A may have typed 30 words every minute. Student A may have opened the assignment at 4:03 P.M. and submitted the assignment at 4:52 P.M. Student B may also submit the homework assignment from a computer in the library. Student B may have typed 28 words per minute. Student B may have opened the assignment at 4:03 P.M. and submitted the assignment at 4:50 P.M. The activity data for Students A and B may be collected and there may be a high probability that the students collaborated on the assignment. The teacher may be provided with an alert indicating the similarities between the two assignments. Other methods of receiving sets of individual-input data may also be possible.

In embodiments, the first set of individual-input data may be compared with the second set of individual-input data at block 322. Generally, comparing can include mapping, contrasting, investigating, evaluating, analyzing, correlating, or examining. The sets of individual-input data may be compared to determine a possible existence of an irregular relationship between the sets of data. A content match may be determined with respect to the first and second sets of individual-input data. Determining can include computing, formulating, generating, or ascertaining. The content match may relate to a level (e.g., number, percentage, benchmark, threshold) of similarities between sets of individual-input data. The content match can include identical content or similar content within a threshold. The content match may be based on word usage or word choice, sentence structure, capitalization, punctuation, spelling (e.g., two individuals make the same spelling error), a similar or the same order or outline (e.g., particularly when the order/outline is different from the correct answer/how a larger group of individuals answers), or the like. The determining may occur based on and in response to comparing the first set of individual-input data with the second set of individual-input data. The irregular relationship may be identified based on the content match with respect to the first and second sets of individual-input data (for the first and second individuals related to the evaluation-activity). Generally, identifying can include recognizing, discovering, distinguishing, detecting, ascertaining, or determining as described herein.

Consider the following example. Two people may be taking the written portion of their driving test. A set of individual-input data may be collected for Person A. Person A might have a particular sequence of answers for first five questions (e.g., A A A A A). Another set of individual-input data may be collected for Person B. Person B may have the exact same sequence of answers for the first five questions (e.g., A A A A A). The content of the answers for Person A and Person B may be compared to one another. An irregular relationship may be identified based on the identical answer content for these two people. As another example, Person A and Person B may be answering an essay question and make the same spelling error (e.g., “breaks” instead of “brakes”). The content of the essay question may be compared and an irregular relationship may be identified based on the identical spelling error of Persons A and B. Other examples of comparing the set of individual-input data and determining a content match may also be possible.

In embodiments, a temporal match for the content match may be determined at block 323. Determining can include computing, calculating, formulating, generating, or ascertaining. The temporal match for the content match may include a length of time, a time frame, a window of time, or the like related to the content match. The temporal match for the content match may include similar content being entered at the same time, at nearly the same time, within a threshold time window, or the like. The determining may occur based on and in response to comparing the first set of individual-input data with the second set of individual-input data. The irregular relationship may be identified based on the temporal match for the content match with respect to the first and second sets of individual-input data (for the first and second individuals related to the evaluation-activity). Identifying can include recognizing, discovering, distinguishing, detecting, ascertaining, or determining as described herein.

Consider the following example. A group of law students may be taking a licensing exam. A set of individual-input data may be collected for the students in the room. The individual-input data may contain the answers to exam questions. A content match may be determined between Student C and Student D. As an example, identical phrases may be detected in the short answer responses of these students. A temporal match may be determined for Student C and D. Student D may finish each question exactly one minute after Student C finishes the same question. The temporal match may indicate suspicious behavior (e.g., Student D waits for Student C to finish writing before copying their answer almost word-for-word). As another example, Student C and Student D may enter nearly identical multiple-choice responses at the exact same time. The temporal match may indicate suspicious behavior (e.g., Student C and Student D may be collaborating/communicating their answers to one another). The proctor may be alerted of the suspicious behavior (e.g., receives a text message with the name and location of the suspected students) in order to more closely monitor these students. Other examples of determining a temporal match for the content match may also be possible.

In embodiments, a frequency of the temporal match for the content match may be determined at block 324. Determining can include computing, calculating, formulating, generating, or ascertaining. The frequency of the temporal match for the content match may include a number of occurrences of a temporal match for the content match (e.g., the number of times a plurality of individuals have been recorded for similar input within a time window). The determining may occur based on and in response to comparing the first set of individual-input data with the second set of individual-input data. The frequency of the temporal match for the content match may be compared with a threshold frequency (with respect to the first and second sets of individual-input data). Generally, comparing can include contrasting, investigating, evaluating, analyzing, correlating, or examining. The threshold frequency may include a value (e.g., number, percentage, benchmark) which indicates a certain level (e.g., high) of frequency of the temporal match for the content match. The comparing may be performed by the dynamic irregularity management engine to streamline dynamic irregularity management. The irregular relationship with respect to the first and second sets of individual information (for the first and second individuals related to the evaluation-activity) may be identified. Identifying can include recognizing, discovering, distinguishing, detecting, ascertaining, or determining as described herein. The identifying may occur based on the frequency of the temporal match for the content match with respect to the first and second sets of individual-input data exceeding the threshold frequency.

Consider the following example. A group of prospective nurses may be taking their licensing exam. A set of activity data may be collected for each nurse in the room to monitor for suspicious activity. As an example, the responses of two of the nurses may be nearly identical, including the incorrect answers. This may indicate a content match (e.g., 90% of the answers are identical). Furthermore, the two nurses may be working at nearly the same pace (e.g., answers one question every three minutes). This may indicate a temporal match for the content match. A frequency of the temporal match for the content match may be calculated. The frequency of the temporal match for the content match for these particular nurses may be calculated as 83% (e.g., the nurses answer 83% of the questions identically and at the same time). For this particular exam, it may be highly unlikely for any two nurses to work at the same pace. A threshold frequency for this exam may be predetermined and may be equal to 60% (e.g., there is a 60% chance that any two nurses answer the questions identically and at the same time). The frequency may be compared to the threshold frequency. Since 83% is much higher than 60%, an alert may be provided to the proctor that the nurses are likely sharing answers. The location of the two nurses may flash on a map of the room to instruct the proctor to closely monitor the two nurses in question. Other examples of determining a frequency of the temporal match for the content match may also be possible.

At block 340, an irregular relationship may be identified with respect to the set of activity data. The identifying may occur based on the set of activity data pertaining to the multiple-individual evaluation-activity environment. The identifying may be performed by the dynamic irregularity management engine in the dynamic fashion to streamline dynamic irregularity management. At block 360, an irregularity event response action may be provided based on the irregular relationship with respect to the set of activity data. The providing may be performed by the dynamic irregularity management engine to streamline dynamic irregularity management. Method 300 concludes at block 399. As described herein, aspects of method 300 relate to dynamic irregularity management in a multiple-individual evaluation-activity environment. Aspects of method 300 may provide performance or efficiency benefits related to dynamic irregularity management. Aspects may save resources such as bandwidth, processing, or memory. As an example, bandwidth may be saved by comparing a frequency of a temporal match for a content match to a benchmark frequency. An administrator may be alerted (e.g., via email, text message) that an individual may be cheating when a frequency exceeds a predetermined threshold. Alerting an administrator for any level of frequency (e.g., instead of only when the frequency exceeds the threshold) may require additional bandwidth to send unnecessary alerts (e.g., alerts when an individual is probably not cheating). Other examples of saving bandwidth using dynamic irregularity management may also be possible.

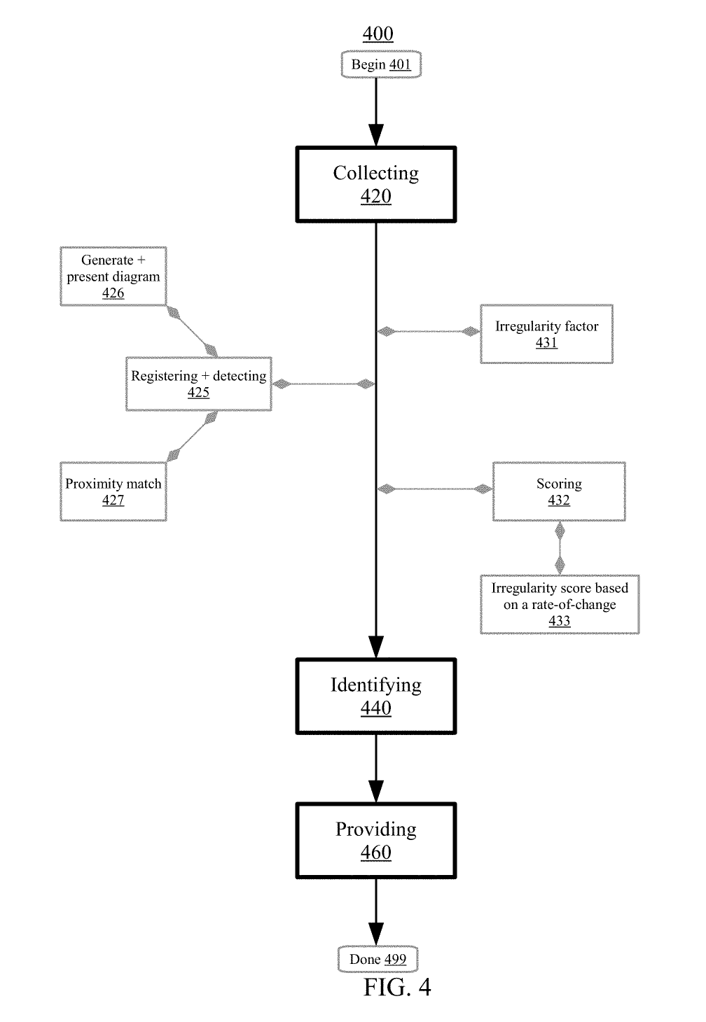

FIG. 4 is a flowchart illustrating a method 400 for dynamic irregularity management in a multiple-individual evaluation-activity environment, according to embodiments. Aspects of method 400 may be similar or the same as aspects of method 200/300, and aspects may be utilized interchangeably with one or more methodologies described herein. The method 400 may begin at block 401. At block 420, a set of activity data pertaining to the multiple-individual evaluation-activity environment may be collected. The set of activity data may include a first set of individual information for a first individual related to an evaluation-activity and a second set of individual information for a second individual related to the evaluation activity. The collecting may be performed by a dynamic irregularity management engine. The collecting may occur in a dynamic fashion to streamline dynamic irregularity management.

In embodiments, both a first input device and a second input device may be registered at block 425. Generally, registering can include recording, logging, submitting, or logging. The first input device may be registered for the first individual related to the evaluation-activity and the second input device may be registered for the second individual related to the evaluation-activity. The input devices may include equipment used by the individual to submit answers (e.g., smart pen, computer keyboard). The registering may be performed by the dynamic irregularity management engine to streamline dynamic irregularity management. As the data is received by the central processing device, the input device of a specific user may be registered with the system, generating a user in a local database. Both a first physical location and a second physical location may be detected. Detecting can include sensing, discovering, distinguishing, recognizing, receiving, monitoring, tracking, or identifying. The first physical location of the first input device may be detected for the first individual related to the evaluation-activity and the second physical location of the second input device may be detected for the second individual related to the evaluation-activity. The detecting may be performed by the dynamic irregularity management engine to streamline dynamic irregularity management. The registering of the identification (e.g., name, ID number) and location of individual users may be used to generate a map of the environment of the evaluation-activity.

In embodiments, a diagram may be generated at block 426. Generating can include formulating, deriving, forming, or producing. The diagram may include an image, a map, a chart, a graph, or the like which may indicate the location of the individuals in the evaluation-activity environment. The diagram may indicate both the first physical location of the first input device (for the first individual related to the evaluation-activity) and the second physical location of the second input device (for the second individual related to the evaluation-activity). In certain embodiments, the diagram may include a heat map of high density suspected cheating areas in the environment or room. The central processing device may display the map of the individuals in the exam room along with their probability of cheating next to each location for the proctor to view (e.g., at all times, continually, ongoing). The generating may be performed by the dynamic irregularity management engine to streamline dynamic irregularity management. The diagram may be presented by the dynamic irregularity management engine (to streamline dynamic irregularity management). Presenting can include providing, displaying, delivering, conveying, or relaying (e.g., to a user). The diagram may indicate both the first physical location of the first input device (for the first individual related to the evaluation-activity) and the second physical location of the second input device (for the second individual related to the evaluation-activity).

Consider the following example. A group of security officers may take an exam to determine whether they should be promoted. The group of officers may take the exam using computers in a computer lab. Each input device (e.g., computer, computer keyboard, computer mouse) may be registered. As an example, Officer 1 may be registered to Computer A, Officer 2 may be registered to Computer B, and so on. Physical locations for each of the input devices may be detected by the dynamic irregularity management engine. Computer A may be located in Row 1 Column 1, Computer B may be located in Row 1 Column 2, and so on. The dynamic irregularity management engine may use the registered devices and their locations to generate a diagram to be used by the proctor. The diagram may be in the form of a map (e.g., each computer/location is marked by a square and labeled with the name of the officer). The diagram may be available for the proctor to view throughout the entire exam. The map may display probability of cheating scores for the officers next to their names. The map may change color based on the probability of cheating score for each officer (e.g., a high probability of cheating may be red, a low probability of cheating may be blue). In this way, the proctor may utilize the diagram to determine which officers may be cheating on the exam. Other examples of generating a diagram may also be possible.

In embodiments, the first physical location and the second physical location may be compared at block 427. Comparing can include contrasting, investigating, evaluating, analyzing, correlating, or examining. The first physical location of the first input device for the first individual related to the evaluation-activity may be compared with the second physical location of the second input device for the second individual related to the evaluation-activity. A proximity match may be determined. Determining can include computing, formulating, identifying, generating, deriving, or ascertaining. The proximity match may relate to a similarity of location of a set of individuals. The proximity match may include a threshold distance between two individuals. The threshold distance may be predetermined or set by an administrator user. The threshold distance may be different for different rooms, environments, tests, or the like. The proximity match may be determined with respect to the first and second physical locations of the first and second input devices (for the first and second individuals related to the evaluation-activity). The determining may occur based on and in response to comparing the first physical location of the first input device for the first individual related to the evaluation-activity and the second physical location of the second input device for the second individual related to the evaluation-activity. The irregular relationship with respect to the first and second sets of individual information (for the first and second individuals related to the evaluation-activity) may be identified. Identifying can include recognizing, discovering, distinguishing, detecting, ascertaining, or determining as described herein. The identifying may occur based on the proximity match with respect to the first and second physical locations of the first and second input devices (for the first and second individuals related to the evaluation-activity).

Consider the following example. A group of game show contestants may be participating in a scavenger hunt. The contestants may work in pairs to find clues scattered across a city. Each pair of contestants may register their smartphones to the dynamic irregularity management engine. The dynamic irregularity management engine may use GPS location to track the contestants. The physical location of Team 3 may closely match the physical location of Team 6. As an example, the location of Team 3 may be tracked as approximately 100 feet behind the location of Team 6 at all times (e.g., indicating that Team 3 is following Team 6 instead of solving the clues on their own). The close proximity (e.g., around 100 feet) of the two teams may indicate a proximity match. An irregular relationship may be identified, and the host of the game show may travel to the location of Team 3 to monitor and check for cheating. Other examples of determining a proximity match may also be possible.

In embodiments, an irregularity factor may be computed at block 431. Computing can include determining, calculating, formulating, generating, or ascertaining. The irregularity factor may include a value (e.g., percentage, number, probability, coefficient, weight) which indicates a level of similarity between the first and second sets of individual information. The irregularity factor may be computed based on the set of activity data with respect to the first and second sets of individual information for the first and second individuals related to the evaluation-activity. The irregularity factor may be based on factors such as distance between individuals, timing between similar input, order of input, number of times an individual has been recorded for similar input, and the like (as described herein). Similarities between two (or more) individuals within a certain temporal period may be recorded and assigned a probability of cheating score. Further suspected cheating of an individual may result in the irregularity factor increasing at a higher rate (e.g., compared to an individual suspected for the first time). The irregularity factor of an individual who has only been suspected once (e.g., stops raising suspicions as the exam continues) may decrease (since it may be unlikely that the individual is cheating). The computing may be performed by the dynamic irregularity management engine to streamline dynamic irregularity management. The irregularity factor may be compared with a threshold factor. Comparing can include contrasting, investigating, evaluating, analyzing, correlating, or examining. The threshold factor may include a predetermined value for the irregularity factor which is considered normal or typical. The comparing may be performed by the dynamic irregularity management engine to streamline dynamic irregularity management. The irregular relationship with respect to the first and second sets of individual information (for the first and second individuals related to the evaluation-activity) may be identified. Identifying can include recognizing, discovering, distinguishing, detecting, ascertaining, or determining as described herein. The identifying may occur based on the irregularity factor achieving (e.g., exceeding) the threshold factor. An irregular relationship may be present if the irregularity factor is greater than the threshold factor.

Consider the following example. A high school math class may be taking a midterm exam using smart pens registered with a dynamic irregularity management engine. The smart pens may record information for each student. Student 11 and Student 14 may have a close proximity in the classroom. The smart pens of both students may record similar outlying errors. As an example, both students may make a simple arithmetical error (e.g., 2+2=6). The students may have answered all of the first 7 questions identically. The students may be working at a similar pace. Due to the outlying error, level of similarity, and similar timing between Student 11 and Student 14, it may be likely that the students are cheating. An irregularity factor may be computed for the students. A level of similarity may be awarded a weight of 2 for each question. Since the first seven questions are identically, the factor for each student may be computed as 14. The similar pace may be weighted a value of 3, and the outlying error may be weighted a value of 10. The irregularity factor for both Student 11 and Student 14 may be equal to 27. The irregularity factor may be compared with a threshold factor. A predetermined irregularity factor for this math class may be calculated as 16 (e.g., the level of similarity/connection between the work of two students may not exceed 16). The irregularity factor for Student 11 and Student 14 greatly exceeds the threshold factor of 16, so an irregular relationship may be present and the students are likely cheating on the exam. As the exam continues, Student 11 and Student 14 may begin to work at a different pace. Due to the difference in timing of the two students, the irregularity factor may decrease (e.g., to 14). Since the newly computed irregularity factor does not exceed the threshold factor, the alert (regarding Student 11 and Student 14) may disappear (e.g., color on the heat map changes back to normal). The teacher may not have to monitor these particular students as closely. Other examples of computing an irregularity factor may also be possible.

In embodiments, a first irregularity score for the first set of individual information (for the first individual related to the evaluation-activity) may be calculated at block 432. Calculating can include computing, estimating, deriving, or determining. The first irregularity score may include a value for a first individual which indicates the probability of cheating (for the particular individual). As an example, an individual who is suspected of cheating may have a high irregularity score, while an individual who is not suspected or barely suspected of cheating may have a low irregularity score. The irregularity score may include a number (e.g., on a scale from 1-10, on a scale from 1-100), a probability (e.g., on a scale from 0-1), a percentage (e.g., 75% chance of cheating), a level/tier (e.g., suspicious, normal), or the like. The calculating may occur based on the set of activity data pertaining to the multiple-individual evaluation-activity environment. The calculating may be performed by the dynamic irregularity management engine in a dynamic fashion to streamline dynamic irregularity management. The first irregularity score (for the first set of individual information for the first individual related to the evaluation-activity) may be compared with a benchmark score. Comparing can include contrasting, investigating, evaluating, analyzing, correlating, or examining. The benchmark score may include a predetermined value for an irregularity factor which may be deemed normal (e.g., average) for an exam. The benchmark score may include group averages, a certain percentile (e.g., the seventy-fifth percentile), the second highest score, or the like. The irregular relationship with respect to the set of activity data may be identified. Identifying can include recognizing, discovering, distinguishing, detecting, ascertaining, or determining as described herein. The identifying may occur based on the first irregularity score for the first set of individual information (for the first individual related to the evaluation-activity) exceeding the benchmark score. An irregular relationship may be present if the irregularity score is greater than the benchmark score.

Consider the following example. A group of boy scouts may be participating in an exam in order to move to the next level. Activity data may be collected for each scout to monitor for cheating. The activity data for Danny may indicate answers which are nearly identical to the answers of other scouts. Many of the copied answers may be incorrect or contain the same spelling errors as other scouts. As an example, Danny may have misspelled the same word as Tyler and copied a wrong answer from Chris. This may result in a high probability that Danny is cheating on the exam. An irregularity score may be computed for Danny. The score may indicate a probability (from 0-1) that Danny is cheating on the exam. Since Danny has copied several errors from other scouts, the irregularity score for Danny may be computed as 0.85. The irregularity score for Danny may be compared with a benchmark score. Generally, scouts participating in the exam may have an irregularity score as high as 0.55 without cheating. The irregularity score for Danny exceeds the benchmark score, so there may be a high probability that Danny is cheating on the exam. A notification may be sent to the scout leader to closely monitor Danny and his exam. Other examples of calculating an irregularity score may also be possible.

In embodiments, the first irregularity score may be configured at block 433. Configuring can include constructing, organizing, or arranging. The first irregularity score (for the first set of individual information for the first individual related to the evaluation-activity) may be configured to be based on a rate-of-change in the first set of individual information (for the first individual related to the evaluation-activity). The rate-of-change may relate to the rate at which an irregularity score may increase or decrease. As the dynamic irregularity management engine continues to suspect further cheating of an individual, the irregularity score may increase at a higher rate (than an individual who is suspected for the first time). If an individual is suspected once and then stops raising suspicions as the exam continues, the irregularity score may decrease.

Consider the following example. A group of law students may be participating in a licensing exam. Activity data may be collected for each law student in order to monitor for suspicious behavior. The activity data may be used to calculate an irregularity score for each student. The irregularity score may indicate a probability that the particular student is cheating on the exam. Student 46 may be awarded an irregularity score of 0.58 (e.g., there is a 58% chance that Student 46 is cheating on the exam). As the exam continues, Student 46 may be further suspected of cheating (e.g., their answers are nearly identical to the student sitting in front of them, they finish each question shortly after the student sitting in front of them finishes each question). The irregularity score of Student 46 may increase to 0.78, indicating a higher probability that this student is cheating on the exam. The proctor may receive an alert to more closely monitor Student 46. As another example, Student 24 may have an irregularity score of 0.54 at the start of the exam (e.g., the pace at which the student is working is similar to the pace of another nearby student). As the exam continues, the irregularity score of Student 24 may decrease to 0.21 (e.g., Student 24 begins working at a slower pace than the nearby student). Due to the lower irregularity score, there may be less of a chance that Student 24 is cheating. The proctor may not receive an alert to monitor this student. Other examples of configuring the irregularity score to be based on a rate-of-change may also be possible.

At block 440, an irregular relationship may be identified with respect to the set of activity data. The identifying may occur based on the set of activity data pertaining to the multiple-individual evaluation-activity environment. The identifying may be performed by the dynamic irregularity management engine in the dynamic fashion to streamline dynamic irregularity management. At block 460, an irregularity event response action may be provided based on the irregular relationship with respect to the set of activity data. The providing may be performed by the dynamic irregularity management engine to streamline dynamic irregularity management. Method 400 concludes at block 499. As described herein, aspects of method 400 relate to dynamic irregularity management in a multiple-individual evaluation-activity environment. Aspects of method 400 may provide performance or efficiency benefits related to dynamic irregularity management. Aspects may save resources such as bandwidth, processing, or memory. As an example, bandwidth may be reduced by using an irregularity score to indicate the probability that a particular individual is cheating. When an irregularity score exceeds a benchmark score, the administrator-user may be provided with an alert that the individual is cheating. Without the use of a benchmark for comparison, an administrator-user may receive false alerts for any change in irregularity score, which would require additional bandwidth (e.g., to send an email alert, to send a text message alert). Other examples of saving bandwidth using dynamic irregularity management may also be possible.

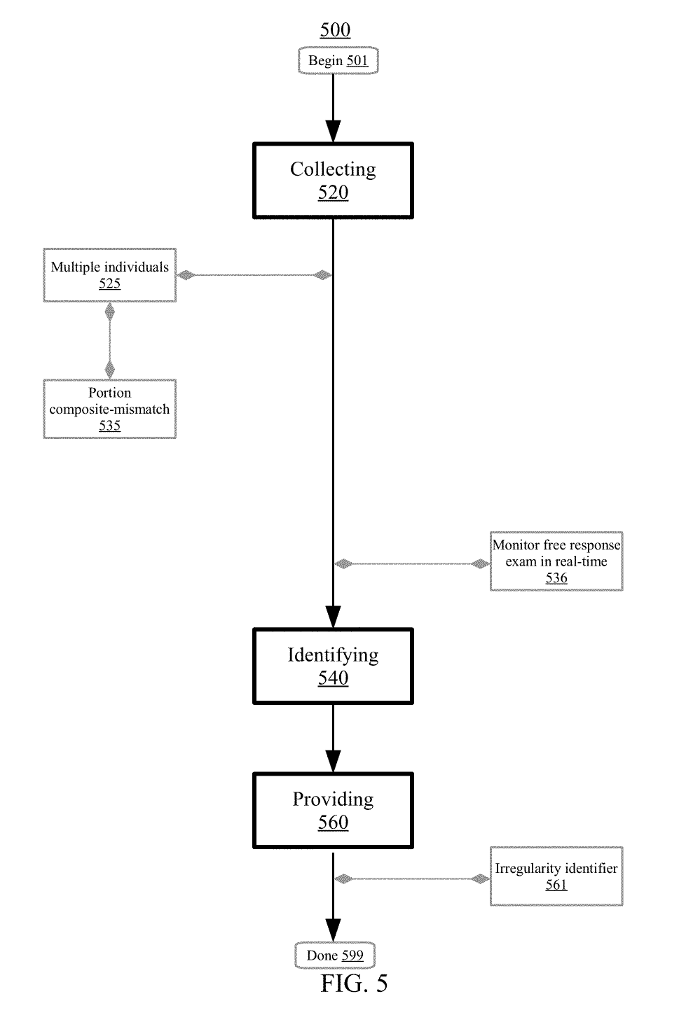

FIG. 5 is a flowchart illustrating a method 500 for dynamic irregularity management in a multiple-individual evaluation-activity environment, according to embodiments. Aspects of method 500 may be similar or the same as aspects of method 200/300/400, and aspects may be utilized interchangeably with one or more methodologies described herein. The method 500 may begin at block 501. At block 520, a set of activity data pertaining to the multiple-individual evaluation-activity environment may be collected. The set of activity data may include a first set of individual information for a first individual related to an evaluation-activity and a second set of individual information for a second individual related to the evaluation activity. The collecting may be performed by a dynamic irregularity management engine. The collecting may occur in a dynamic fashion to streamline dynamic irregularity management.

In embodiments, the set of activity data may include a third set of individual information for a third individual related to the evaluation-activity at block 525. The third set of individual information may include data pertaining to a third individual. As an example, the first individual may be cheating off multiple individuals (e.g., the second and third individuals). A first portion match may be ascertained. Ascertaining can include determining, computing, resolving, formulating, or identifying. The ascertaining may occur by comparing a first portion of the first set of individual information for the first individual related to the evaluation-activity with a first portion of the second set of individual information for the second individual related to the evaluation-activity. The first portion may include a first segment of input for an examination (e.g., the answer to the first question). The first portion match may include a level of similarity between the first portion of an individual and the first portion of another individual (e.g., very similar correct/incorrect answers entered at nearly the same time). The first portion match may indicate a first irregularity score. As an example, the answer to the first question on the exam of the first individual may be compared with the answer to the first question on the exam of the second individual. A second portion match which indicates a second irregularity score may be ascertained. The ascertaining may occur by comparing a second portion of the first set of individual information for the first individual related to the evaluation-activity with a second portion of the third set of individual information for the third individual related to the evaluation-activity. As an example, the answer to the second question on the exam of the first individual may be compared with the answer to the second question on the exam of the third individual. The irregular relationship with respect to the set of activity data which correlates to the first set of individual information (for the first individual related to the evaluation-activity) may be identified. Identifying can include recognizing, discovering, distinguishing, detecting, ascertaining, or determining as described herein. The identifying may occur based on the first and second irregularity scores (e.g., a cumulative score which exceeds a threshold). If the first and second irregularity scores exceed a benchmark threshold score, an irregular relationship may be present.

Consider the following example. Several students may submit a homework assignment using a dynamic irregularity management engine. Student A may have copied answers from multiple students (e.g., Student B and Student C). A first portion match may be ascertained by comparing the homework assignment of Student A and Student B. Student A may have copied an incorrect answer from Student B for Question 1. The identical incorrect answer may indicate that Student A and Student B may have cheated. Both students may be awarded an irregularity score of 60 (e.g., out of 100). A second portion match may be ascertained by comparing the homework assignment of Student A and Student C. Student A may have copied another incorrect answer from Student C for Question 2. The identical incorrect answer may indicate that Student A and Student C may have cheated. The irregularity score for Student C may be calculated as 60. The irregularity score for Student A may increase to 85 based on two incorrect answers copied from other students. The irregular relationship may be identified, indicating that Student A has been copying homework assignments of other students. The teacher may wish to more closely monitor assignments submitted by Student A. Other examples of portion matching may also be possible.

In embodiments, a first portion composite-mismatch may be ascertained at block 535. Ascertaining can include determining, computing, resolving, formulating, deriving, or identifying a first portion composite-mismatch. The first portion composite-mismatch may include a response which is outside of a normal composite bounds (e.g., for the group of individuals as a whole). The first portion composite-mismatch may include an answer which is extremely incorrect, extremely correct, rare, or the like. The first portion composite-mismatch may indicate a third irregularity score. The ascertaining may occur by comparing the first portion of the first set of individual information for the first individual related to the evaluation-activity with a first portion of a composite set of individual information for a plurality of individuals related to the evaluation-activity. A second portion composite-mismatch may be ascertained. The second portion composite-mismatch may indicate a fourth irregularity score. The ascertaining may occur by comparing the second portion of the first set of individual information for the first individual related to the evaluation-activity with a second portion of the composite set of individual information for the plurality of individuals related to the evaluation-activity. The irregular relationship with respect to the set of activity data which correlates to the first set of individual information (for the first individual related to the evaluation-activity) may be identified. Identifying can include recognizing, discovering, distinguishing, detecting, ascertaining, or determining as described herein. The identifying may occur based on the third and fourth irregularity scores.

Consider the following example. A college history class may take a final exam using a dynamic irregularity management engine. The exam may cover historical events in the 1930s, but Student 1 and Student 2 may write about 1883 in a short-answer question. This outlying answer may be determined as a portion-composite mismatch (e.g., the short-answer response is extremely incorrect as it addresses a different century). The likelihood that multiple students would make that particular error may be very low (e.g., a 2% chance). Due to the unlikeliness of this mistake, it may be very likely that Student 1 and Student 2 are cheating on the exam. An alert may be provided to the professor to more closely monitor these two students. As another example, the professor may include a bonus question which only 1% of students generally answer correctly. Four students (sitting in close proximity to one another) may all answer the question correctly. A portion composite-mismatch may be ascertained since it is very unlikely that so many students would answer the bonus question correctly. The professor may receive an alert to more closely monitor these students for suspicious behavior. Other examples of ascertaining a portion composite-mismatch may also be possible.

In embodiments, a set of free response exam input may be monitored at block 536. Monitoring can include detecting, recognizing, tracking, or discovering. The monitoring may occur in real-time with respect to a free response exam. The free response exam may include an essay or short answer question. The monitoring may occur using an input-tracking technique to detect the irregular relationship and provide a real-time response (e.g., rather than after the exam). The input of individuals may be monitored for irregularities. The dynamic irregularity management engine may track the keyboard of a computer (e.g., which keys are being hit, number of words typed per minute, how hard the keys are being hit), the movement of a smart pen (e.g., letters written, pace of writing), audio input (e.g., word choice, fluency of speech), and the like.

Consider the following example. A group of security officers may be participating in an advancement examination involving an essay question. The security officers may handwrite the essays using smart pens, which record the input to collect a set of activity data for each officer. The input from the smart pens may be monitored in real-time for irregular relationships and patterns. As an example, Officer D and Officer G may utilize many of the same phrases while writing their essays. The smart pens may be used to detect a 30% similarity between the essay of Officer D and Officer G. In an essay examination of this type, the normal level of similarity between two essays may be predetermined as 12%. Based on the calculated level of similarity, it may be determined that Officer D and Officer G might be cheating after only writing one page. The proctor may wish to more closely monitor these two officers for the rest of the exam. As the exam continues (e.g., by the fourth page), the level of similarity between the essays of Officers D and G may decrease to a level of 10%. Based on the newly calculated level of similarity, it may be determined that Officers D and G are probably not cheating. The proctor may choose to monitor other officers instead. Other examples of monitoring a set of free response exam inputs may also be possible.

At block 540, an irregular relationship may be identified with respect to the set of activity data. The identifying may occur based on the set of activity data pertaining to the multiple-individual evaluation-activity environment. The identifying may be performed by the dynamic irregularity management engine in the dynamic fashion to streamline dynamic irregularity management. At block 560, an irregularity event response action may be provided based on the irregular relationship with respect to the set of activity data. The providing may be performed by the dynamic irregularity management engine to streamline dynamic irregularity management.

In embodiments, the irregularity event response action may be structured at block 561. Generally, structuring can include assembling, formatting, organizing, or arranging. The irregularity event response action may be structured to include an irregularity identifier. The irregularity identifier may include an indication (e.g., to a proctor) of a location or a specific individual with a high probability of cheating. The proctor may be identified through a name, seat number, and cheating score. The irregularity event response action may provide an alert to suggest the proctor more closely monitor the area of suspected cheating. The map of individuals in the exam room may be displayed along with their accumulated cheating score next to each seat for the proctor to view (e.g., at all times).

Consider the following example. A group of people may be taking a computerized test to obtain their drivers licenses. The administrator overseeing the exam may be provided with a diagram/map of the individuals participating in the test. The administrator can monitor (e.g., at all times) a color-coded map on a computer screen (e.g., a tablet). The individuals may be labeled at their various locations by name and computer number. The irregularity score of each individual may appear next to their name and computer number. High irregularity scores may appear in red to alert the administrator to monitor these individuals, while average irregularity scores appear in yellow and lower irregularity scores may appear in green. Three individuals farthest away from the administrator may have high irregularity scores. This may be indicated on the map (e.g., “Bob Brown, Computer 36, 94” “Amy White, Computer 37, 92” “George Black, Computer 38, 97” appearing in red). The administrator can walk to the back of the room to more closely monitor these three individuals for cheating. The administrator may see the cheating scores of these three individuals slowly decrease (e.g., by watching the tablet screen). After a while, the (previously green) irregularity scores of the individuals in the front of the room may change to yellow, indicating an increasing score/probability of cheating. The administrator may detect this on the tablet screen and decide to monitor the front of the room instead. Other methods of structuring the irregularity event response action to include an irregularity identifier may also be possible.

Method 500 concludes at block 599. As described herein, aspects of method 500 relate to dynamic irregularity management in a multiple-individual evaluation-activity environment. Aspects of method 500 may provide performance or efficiency benefits related to dynamic irregularity management. Aspects may save resources such as bandwidth, processing, or memory. As an example, monitoring a set of free response exam inputs in real-time may save memory. An input-tracking technique may be used to monitor free response exam inputs for irregularities dynamically (e.g., during the examination). This may prevent an administrator-user from searching for irregularities in free response exam inputs manually (e.g., searching on a computing device for similar phrases in responses) which would require larger amounts of memory usage. Other examples of using dynamic irregularity management to save memory may also be possible.

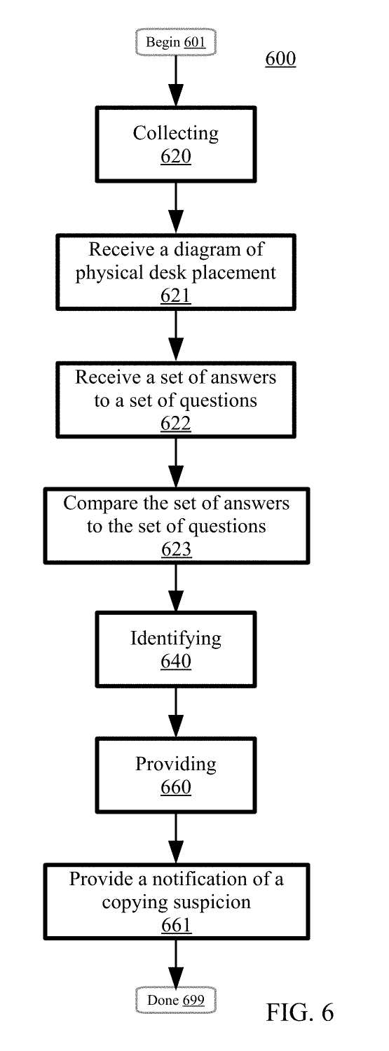

FIG. 6 is a flowchart illustrating a method 600 for dynamic irregularity management in a multiple-individual evaluation-activity environment, according to embodiments. Aspects of method 600 may be similar or the same as aspects of method 200/300/400/500, and aspects may be utilized interchangeably with one or more methodologies described herein. The method 600 may begin at block 601. At block 620, a set of activity data pertaining to the multiple-individual evaluation-activity environment may be collected. The set of activity data may include a first set of individual information for a first individual related to an evaluation-activity and a second set of individual information for a second individual related to the evaluation activity. The collecting may be performed by a dynamic irregularity management engine. The collecting may occur in a dynamic fashion to streamline dynamic irregularity management. At block 621, a diagram (e.g., chart, map, graph, image) of physical desk placement (e.g., grid, columns, rows, sections) of exam takers taking the exam may be received. Receiving can include detecting, collecting, recognizing, acquiring, sensing, or accepting. The receiving may occur to monitor an exam for answer copying (e.g., similar answers, identical answers, unusual answers, responses entered at nearly the same time). At block 622, a set of answers to a set of questions from the set of exam takers may be received. The receiving may occur at a set of times (e.g., concurrently, linked such that one person answers each question exactly one minute after another). The receiving may occur to monitor the exam for answer copying. At block 623, the set of answers to the set of questions from the set of exam takers may be compared. Comparing can include contrasting, investigating, evaluating, analyzing, correlating, or examining. The comparing may occur according to a copying criteria (e.g., outlier words, a number of identical phrases, similar phrases, timing consistencies, spelling errors, grammatical errors) to form a copying assessment (e.g., software used to detect similarities/outliers, plagiarism system).

At block 640, an irregular relationship may be identified with respect to the set of activity data. The identifying may occur based on the set of activity data pertaining to the multiple-individual evaluation-activity environment. The identifying may be performed by the dynamic irregularity management engine in the dynamic fashion to streamline dynamic irregularity management. At block 660, an irregularity event response action may be provided based on the irregular relationship with respect to the set of activity data. The providing may be performed by the dynamic irregularity management engine to streamline dynamic irregularity management. At block 661, a notification of a copying suspicion may be provided. Providing may include generating, placing, deploying, or transmitting a notification (e.g., alert, alarm, text message, email, flashing notification). The providing may occur in response to the copying assessment exceeding a predetermined suspicion threshold (e.g., 90% chance that an individual is cheating compared to a benchmark suspicion threshold of 70%).

Consider the following example. A group of college students may be participating in a final exam. A map of the exam room may be generated for the professor, indicating (e.g., via labels) where each student is sitting. A set of answers to questions may be collected from each individual student. These answers may be compared to one another based on a criteria to indicate if any students are suspected of cheating on the exam. An irregularity may be identified between the exams of Jim and Pam. As an example, both students may have misspelled “Abraham Lincoln” multiple times. A simple but repeated spelling error on the exams of two different students may indicate that Jim and Pam were copying from one another. An alert may be provided to the professor that Jim and Pam are probably cheating. The map of the exam room may change color to indicate to the professor of a cheating event. As an example, the labeled desks of Jim and Pam may flash in orange. In this way, the professor may be notified of a copying suspicion. Other examples of using dynamic irregularity management may also be possible.

Method 600 concludes at block 699. As described herein, aspects of method 600 relate to dynamic irregularity management in a multiple-individual evaluation-activity environment. Aspects of method 600 may provide performance or efficiency benefits related to dynamic irregularity management. Aspects may save resources such as bandwidth, processing, or memory. As an example, processing time may be saved by dynamically (e.g., in real-time) monitoring students for cheating activities. Monitoring each exam in real-time may prevent an administrator-user from manually having to search exams for suspicious answers. Also, an administrator may receive a notification only if an individual is suspected of cheating. This may prevent the administrator from having to constantly monitor every individual (e.g., the administrator only has to monitor those suspected of cheating). Other examples of saving processing time using dynamic irregularity management may also be possible.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

What is claimed is:

1. A computer-implemented method for dynamic irregularity management in a multiple-individual evaluation-activity environment, the method comprising:
collecting, by a dynamic irregularity management engine in a dynamic fashion to streamline dynamic irregularity management, a set of activity data pertaining to the multiple-individual evaluation-activity environment, wherein the set of activity data includes:
a first set of individual information for a first individual related to an evaluation-activity, and
a second set of individual information for a second individual related to the evaluation-activity;
identifying, based on the set of activity data pertaining to the multiple-individual evaluation-activity environment and by the dynamic irregularity management engine in the dynamic fashion to streamline dynamic irregularity management, an irregular relationship with respect to the set of activity data; and
providing, by the dynamic irregularity management engine to streamline dynamic irregularity management, an irregularity event response action based on the irregular relationship with respect to the set of activity data.

2. The method of claim 1, further comprising:
receiving, corresponding to the first individual related to the evaluation-activity, a first set of individual-input data;
receiving, corresponding to the second individual related to the evaluation-activity, a second set of individual-input data; and
assembling, using the first and second sets of individual-input data, the set of activity data which has the first set of individual information for the first individual related to the evaluation-activity and the second set of individual information for the second individual related to the evaluation-activity.

3. The method of claim 1, further comprising:
registering, by the dynamic irregularity management engine to streamline dynamic irregularity management, both a first input device for the first individual related to the evaluation-activity and a second input device for the second individual related to the evaluation-activity; and
detecting, by the dynamic irregularity management engine to streamline dynamic irregularity management, both a first physical location of the first input device for the first individual related to the evaluation-activity and a second physical location of the second input device for the second individual related to the evaluation-activity.

4. The method of claim 3, further comprising:
generating, by the dynamic irregularity management engine to streamline dynamic irregularity management, a diagram which indicates both the first physical location of the first input device for the first individual related to the evaluation-activity and the second physical location of the second input device for the second individual related to the evaluation-activity; and
presenting, by the dynamic irregularity management engine to streamline dynamic irregularity management, the diagram which indicates both the first physical location of the first input device for the first individual related to the evaluation-activity and the second physical location of the second input device for the second individual related to the evaluation-activity.

5. The method of claim 1, further comprising:
computing, by the dynamic irregularity management engine to streamline dynamic irregularity management, an irregularity factor based on the set of activity data with respect to the first and second sets of individual information for the first and second individuals related to the evaluation-activity;
comparing, by the dynamic irregularity management engine to streamline dynamic irregularity management, the irregularity factor with a threshold factor; and
identifying, based on the irregularity factor achieving the threshold factor, the irregular relationship with respect to the first and second sets of individual information for the first and second individuals related to the evaluation-activity.

6. The method of claim 2, further comprising:
comparing the first set of individual-input data with the second set of individual-input data;
determining, based on and in response to comparing the first set of individual-input data with the second set of individual-input data, a content match with respect to the first and second sets of individual-input data; and
identifying, based on the content match with respect to the first and second sets of individual-input data, the irregular relationship with respect to the first and second sets of individual information for the first and second individuals related to the evaluation-activity.

7. The method of claim 6, further comprising:
determining, based on and in response to comparing the first set of individual-input data with the second set of individual-input data, a temporal match for the content match with respect to the first and second sets of individual-input data; and
identifying, based on the temporal match for the content match with respect to the first and second sets of individual-input data, the irregular relationship with respect to the first and second sets of individual information for the first and second individuals related to the evaluation-activity.

8. The method of claim 7, further comprising:
determining, based on and in response to comparing the first set of individual-input data with the second set of individual-input data, a frequency of the temporal match for the content match with respect to the first and second sets of individual-input data;
comparing, by the dynamic irregularity management engine to streamline dynamic irregularity management, the frequency of the temporal match for the content match with respect to the first and second sets of individual-input data with a threshold frequency; and
identifying, based on the frequency of the temporal match for the content match with respect to the first and second sets of individual-input data exceeding the threshold frequency, the irregular relationship with respect to the first and second sets of individual information for the first and second individuals related to the evaluation-activity.

9. The method of claim 3, further comprising:
comparing the first physical location of the first input device for the first individual related to the evaluation-activity and the second physical location of the second input device for the second individual related to the evaluation-activity;
determining, based on and in response to comparing the first physical location of the first input device for the first individual related to the evaluation-activity and the second physical location of the second input device for the second individual related to the evaluation-activity, a proximity match with respect to the first and second physical locations of the first and second input devices for the first and second individuals related to the evaluation-activity; and
identifying, based on the proximity match with respect to the first and second physical locations of the first and second input devices for the first and second individuals related to the evaluation-activity, the irregular relationship with respect to the first and second sets of individual information for the first and second individuals related to the evaluation-activity.

10. The method of claim 1, wherein the set of activity data includes a third set of individual information for a third individual related to the evaluation-activity, and further comprising:
ascertaining, by comparing a first portion of the first set of individual information for the first individual related to the evaluation-activity with a first portion of the second set of individual information for the second individual related to the evaluation-activity, a first portion match which indicates a first irregularity score;
ascertaining, by comparing a second portion of the first set of individual information for the first individual related to the evaluation-activity with a second portion of the third set of individual information for the third individual related to the evaluation-activity, a second portion match which indicates a second irregularity score; and
identifying, based on the first and second irregularity scores, the irregular relationship with respect to the set of activity data which correlates to the first set of individual information for the first individual related to the evaluation-activity.

11. The method of claim 10, further comprising:
ascertaining, by comparing the first portion of the first set of individual information for the first individual related to the evaluation-activity with a first portion of a composite set of individual information for a plurality of individuals related to the evaluation-activity, a first portion composite-mismatch which indicates a third irregularity score;
ascertaining, by comparing the second portion of the first set of individual information for the first individual related to the evaluation-activity with a second portion of the composite set of individual information for the plurality of individuals related to the evaluation-activity, a second portion composite-mismatch which indicates a fourth irregularity score; and
identifying, based on the third and fourth irregularity scores, the irregular relationship with respect to the set of activity data which correlates to the first set of individual information for the first individual related to the evaluation-activity.

12. The method of claim 1, further comprising:
calculating, based on the set of activity data pertaining to the multiple-individual evaluation-activity environment and by the dynamic irregularity management engine in the dynamic fashion to streamline dynamic irregularity management, a first irregularity score for the first set of individual information for the first individual related to the evaluation-activity;
comparing the first irregularity score for the first set of individual information for the first individual related to the evaluation-activity with a benchmark score; and
identifying, based on the first irregularity score for the first set of individual information for the first individual related to the evaluation-activity exceeding the benchmark score, the irregular relationship with respect to the set of activity data.

13. The method of claim 12, further comprising:
configuring the first irregularity score for the first set of individual information for the first individual related to the evaluation-activity to be based on a rate-of-change in the first set of individual information for the first individual related to the evaluation-activity.

14. The method of claim 1, further comprising:
structuring the irregularity event response action to include an irregularity identifier.

15. The method of claim 1, further comprising:
monitoring, in real-time with respect to a free response exam, a set of free response exam inputs using an input-tracking technique to detect the irregular relationship.

16. The method of claim 1, further comprising:
receiving, to monitor an exam for answer copying, a diagram of physical desk placement of exam takers taking the exam;
receiving, to monitor the exam for answer copying, a set of answers to a set of questions from the set of exam takers at a set of times;
comparing, according to a copying criteria to form a copying assessment, the set of answers to the set of questions from the set of exam takers; and
providing, in response to the copying assessment exceeding a predetermined suspicion threshold, a notification of a copying suspicion.

17. The method of claim 1, further comprising:
executing, in an automated fashion without user intervention, each of:
the collecting, the identifying, and the providing.

18. The method of claim 1, further comprising:
registering, by the dynamic irregularity management engine to streamline dynamic irregularity management, both a first input device for the first individual related to the evaluation-activity and a second input device for the second individual related to the evaluation-activity;
detecting, by the dynamic irregularity management engine to streamline dynamic irregularity management, both a first physical location of the first input device for the first individual related to the evaluation-activity and a second physical location of the second input device for the second individual related to the evaluation-activity;
receiving, corresponding to the first individual related to the evaluation-activity, a first set of individual-input data;
receiving, corresponding to the second individual related to the evaluation-activity, a second set of individual-input data;
assembling, using the first and second sets of individual-input data, the set of activity data which has the first set of individual information for the first individual related to the evaluation-activity and the second set of individual information for the second individual related to the evaluation-activity;
comparing the first set of individual-input data with the second set of individual-input data;
determining, based on and in response to comparing the first set of individual-input data with the second set of individual-input data, a content match with respect to the first and second sets of individual-input data;
identifying, based on the content match with respect to the first and second sets of individual-input data, the irregular relationship with respect to the first and second sets of individual information for the first and second individuals related to the evaluation-activity;
determining, based on and in response to comparing the first set of individual-input data with the second set of individual-input data, a temporal match for the content match with respect to the first and second sets of individual-input data;
identifying, based on the temporal match for the content match with respect to the first and second sets of individual-input data, the irregular relationship with respect to the first and second sets of individual information for the first and second individuals related to the evaluation-activity;
determining, based on and in response to comparing the first set of individual-input data with the second set of individual-input data, a frequency of the temporal match for the content match with respect to the first and second sets of individual-input data;
comparing, by the dynamic irregularity management engine to streamline dynamic irregularity management, the frequency of the temporal match for the content match with respect to the first and second sets of individual-input data with a threshold frequency;
identifying, based on the frequency of the temporal match for the content match with respect to the first and second sets of individual-input data exceeding the threshold frequency, the irregular relationship with respect to the first and second sets of individual information for the first and second individuals related to the evaluation-activity;
comparing the first physical location of the first input device for the first individual related to the evaluation-activity and the second physical location of the second input device for the second individual related to the evaluation-activity;
determining, based on and in response to comparing the first physical location of the first input device for the first individual related to the evaluation-activity and the second physical location of the second input device for the second individual related to the evaluation-activity, a proximity match with respect to the first and second physical locations of the first and second input devices for the first and second individuals related to the evaluation-activity;
identifying, based on the proximity match with respect to the first and second physical locations of the first and second input devices for the first and second individuals related to the evaluation-activity, the irregular relationship with respect to the first and second sets of individual information for the first and second individuals related to the evaluation-activity;
generating, by the dynamic irregularity management engine to streamline dynamic irregularity management, a diagram which indicates both the first physical location of the first input device for the first individual related to the evaluation-activity and the second physical location of the second input device for the second individual related to the evaluation-activity; and
presenting, by the dynamic irregularity management engine to streamline dynamic irregularity management, the diagram which indicates both the first physical location of the first input device for the first individual related to the evaluation-activity and the second physical location of the second input device for the second individual related to the evaluation-activity.

19. A system for dynamic irregularity management in a multiple-individual evaluation-activity environment, the system comprising:
a memory having a set of computer readable computer instructions, and a processor for executing the set of computer readable instructions, the set of computer readable instructions including:
collecting, by a dynamic irregularity management engine in a dynamic fashion to streamline dynamic irregularity management, a set of activity data pertaining to the multiple-individual evaluation-activity environment, wherein the set of activity data includes:
a first set of individual information for a first individual related to an evaluation-activity, and
a second set of individual information for a second individual related to the evaluation-activity;
identifying, based on the set of activity data pertaining to the multiple-individual evaluation-activity environment and by the dynamic irregularity management engine in the dynamic fashion to streamline dynamic irregularity management, an irregular relationship with respect to the set of activity data; and
providing, by the dynamic irregularity management engine to streamline dynamic irregularity management, an irregularity event response action based on the irregular relationship with respect to the set of activity data.

20. A computer program product for dynamic irregularity management in a multiple-individual evaluation-activity environment, the computer program product comprising a computer readable storage medium having program instructions embodied therewith, wherein the computer readable storage medium is not a transitory signal per se, the program instructions executable by a processor to cause the processor to perform a method comprising:
collecting, by a dynamic irregularity management engine in a dynamic fashion to streamline dynamic irregularity management, a set of activity data pertaining to the multiple-individual evaluation-activity environment, wherein the set of activity data includes:
a first set of individual information for a first individual related to an evaluation-activity, and
a second set of individual information for a second individual related to the evaluation-activity;
identifying, based on the set of activity data pertaining to the multiple-individual evaluation-activity environment and by the dynamic irregularity management engine in the dynamic fashion to streamline dynamic irregularity management, an irregular relationship with respect to the set of activity data; and
providing, by the dynamic irregularity management engine to streamline dynamic irregularity management, an irregularity event response action based on the irregular relationship with respect to the set of activity data.
